(19) United States
(12) Patent Application Publication
(10) Pub. No.: US 2018/0128042 A1
(43) Pub. Date: May 10, 2018

(54) INSULATING GLASS ASSEMBLY

(71) Applicant: Qinhuangdao High-Tech Energy-Saving Dorwin Co., Ltd., Qinhuangdao (CN)

(72) Inventor: Jiyin Chang, Qinhuangdao (CN)

(21) Appl. No.: 15/472,459

(22) Filed: Mar. 29, 2017

(30) Foreign Application Priority Data
Nov. 8, 2016 (CN) 201621202618.7

(51) Int. Cl. E06B 7/28; E06B 3/24; E06B 3/66; B32B 17/06; B32B 7/04

(52) U.S. Cl. CPC E06B 7/28; E06B 3/24; B32B 2307/304; B32B 17/063; B32B 7/045; E06B 3/66

(57) ABSTRACT

The disclosure provides an insulating glass assembly including a piece of insulating glass and a gas compensator. The gas compensator is communicated with the insulating glass. The gas compensator includes a variable body and a vent pipe hermetically connected with the variable body. The vent pipe is in communication with atmosphere.

### CROSS-REFERENCE TO RELATED APPLICATION

This application claims the benefit of Chinese Patent Application No. 201621202618.7 filed on Nov. 8, 2016 in the State Intellectual Property Office of China, the whole disclosure of which is incorporated herein by reference.

### TECHNICAL FIELD

Embodiments of the disclosure relate to a piece of insulating glass, in particular to an insulting glass assembly.

### BACKGROUND

FIGS. 1A and 1B show a schematic cross-section view of an insulating glass assembly in the prior art. As shown in FIG. 1A, in a condition of low temperature, internal gas contained within a piece of insulating glass contracts as cooled to generate a negative pressure and an atmospheric pressure then pushes against the insulating glass inwardly such that a shutter blind arranged in the insulating glass is pressed/squeezed by the glass which is deformed so as to operate only in a restricted condition. As shown in FIG. 1B, in a condition of high temperature, the internal gas contained within the insulating glass expands as heated, and a pressure of the internal gas which is greater than the atmospheric pressure pushes against the insulating glass outwardly.

In order to avoid the above problems, a metal breathable pipe is directly provided within the insulating glass assembly so as to equalize/balance pressure difference between internal and external pressures. The metal breathable pipe releases an inert gas with the heat-expansion and cold-contraction of the insulating glass, which may result in a deterioration of heat insulation performance of the insulating glass assembly.

### SUMMARY

According to embodiments of the disclosure, there is provided an insulating glass assembly comprising a piece of insulating glass and a gas compensator, wherein the gas compensator is communicated with the insulating glass, the gas compensator comprises a variable body and a vent pipe hermetically connected with the variable body, the vent pipe being in communication with atmosphere.

According to an exemplary embodiment of the disclosure, the variable body is provided with a hole at an upper end thereof, through which the vent pipe passes.

According to an exemplary embodiment of the disclosure, the insulating glass comprises an inner glass layer and an outer glass layer, and an interlayer is arranged between the inner glass layer and the outer glass layer and filled with an inert gas.

According to an exemplary embodiment of the disclosure, the insulating glass assembly further comprises a frame fixing the insulating glass and the gas compensator, and the vent pipe is communicated with the atmosphere through the frame and hermetically connected with the frame.

According to an exemplary embodiment of the disclosure, the gas compensator is made of rubber.

According to an exemplary embodiment of the disclosure, the gas compensator further comprises a piston and a spring.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present disclosure, it will now be described by way of example, with reference to the accompanying drawings in which embodiments of the disclosures are illustrated and, together with the descriptions below, serve to explain the principles of the disclosure.

FIG. 1A is a schematic cross-section view of an insulating glass assembly in the prior art, in a condition of cold-contraction;

FIG. 1B is a schematic cross-section view of an insulating glass assembly in the prior art, in a condition of heat-expansion;

FIG. 2A is a schematic cross-section view of an insulating glass assembly according to an exemplary embodiment of the disclosure, in a condition of cold-contraction;

FIG. 2B is a schematic cross-section view of an insulating glass assembly according to an exemplary embodiment of the disclosure, in a condition of heat-expansion; and

FIG. 3 is a schematic structural view of a gas compensator according to an exemplary embodiment of the disclosure.

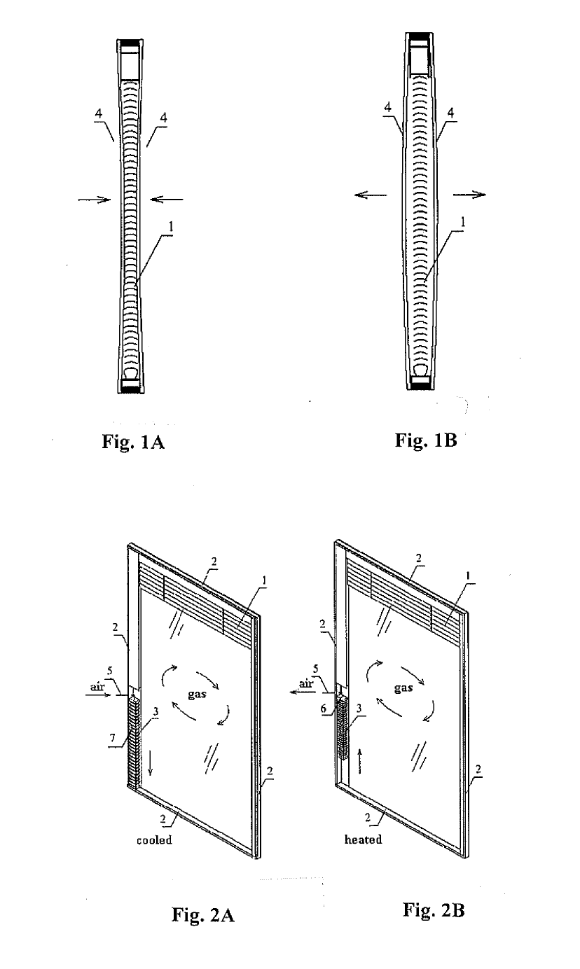

### DETAILED DESCRIPTION

Embodiments of the disclosure will be described in details below with reference to the accompanying drawings. The following descriptions are intended to be illustrative and should not be considered to limit the scope of the disclosure.

According to a general inventive concept of the disclosure, there is provided an insulating glass assembly which comprises an insulating glass assembly comprising a piece of insulating glass and a gas compensator, wherein the gas compensator is communicated with the insulating glass, the gas compensator comprises a variable body and a vent pipe hermetically connected with the variable body, the vent pipe being in communication with atmosphere.

In addition, in the following detailed description, for ease of interpretation, numerous specific details are set forth so as to provide a comprehensive understanding to the disclosure. However, it is apparent that one or more embodiments may be carried out without these specific details. In other cases, well-known structures and devices are illustrated to simplify the drawings.

As shown in FIGS. 2A and 2B, an insulating glass assembly according to an exemplary embodiment of the disclosure comprises a piece of insulating glass 4 and a gas compensator 3, wherein the gas compensator 3 is communicated with the insulating glass 4, the gas compensator 3 comprises a variable body 7 and a vent pipe 5 hermetically connected with each other, and the vent hole 5 is in communication with an atmosphere.

As further illustrated in FIGS. 2A and 2B, according to an embodiment of the disclosure, the variable body 7 is provided with a hole 6 at an upper end thereof, through which the vent pipe 5 passes.

As further illustrated in FIGS. 2A and 2B, the insulating glass 4 comprises an inner glass layer and an outer glass layer. An interlayer is arranged between the inner glass layer and outer glass layer and is filled with an inert gas. The insulating glass assembly further comprises a frame 2 for fixing the insulating glass 4 and the gas compensator 3. The vent pipe 5 is communicated with the atmosphere through the frame 2 and is hermetically connected with the frame 2. The gas compensator 3 is made of rubber.

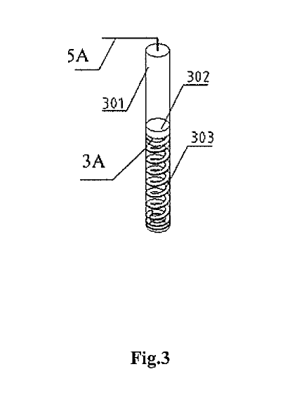

As illustrated in FIG. 3, according to the embodiment of the disclosure, the gas compensator 3 further comprises a piston 302 and a spring 303.

Referring again to FIGS. 2A and 2B, a schematic view of the insulating glass assembly according to the embodiment of the disclosure is illustrated, in conditions of both cold-contraction and heat-expansion. The gas compensator 3 is communicated with the insulating glass 4 so as to form two separated cavities which are insulated from and thus not mutually communicated with each other.

According to the embodiment of the disclosure, the insulating glass assembly comprises the inner glass layer and the outer glass layer, and then interlayer is arranged between the inner glass layer and the outer glass layer and is filled with the inert gas. The insulating glass assembly is provided with a shutter blind 1 and the gas compensator 3. The frame 2 fixes the gas compensator 3 and the insulating glass 4. The gas compensator 3 comprises the variable body 7 and the vent pipe 5. The vent pipe 5 passes through the hole 6 at the upper end of the variable body 7 and is hermetically connected therewith. The vent pipe 5 is hermetically connected with the frame 2. When an atmospheric pressure is balanced with a pressure of the gas contained within in the insulating glass 4, the shutter blind 1 may be reliably lifted.

When the atmospheric temperature is changed, a pressure difference is generated between the atmospheric pressure and the pressure of the gas contained within the insulating glass 4. In order to maintain the balance between the atmospheric pressure and the pressure of the gas in the insulating glass 4, the gas is sucked into or discharged from the gas compensator 3 through the vent pipe 5 so as to avoid the pressure difference from being generated in the insulating glass 4 due to the thermal expansion and cold shrinkage. When the atmospheric temperature is decreased, the pressure in the insulating glass 4 is decreased. Thus, the gas compensator 3 is subject to a negative pressure in the insulating glass 4 so that the variable body 7 extends and the air is sucked from the atmosphere through the vent pipe 5, such that a volume of the variable body 7 is increased to maintain the balance between the internal and external pressure of the insulating glass 4. When the atmospheric temperature is increased, the pressure in the insulating glass 4 is increased. Thus, the gas compensator 3 is subject to the pressure in the insulating glass 4 so that the variable body 7 is compressed and thus the volume of the variable body 7 is decreased, and the air is discharged through the vent pipe 5 so that the balance between the internal and external pressure of the insulating glass 4 is maintained.

FIG. 3 is a schematic structural view of a gas compensator according to an exemplary embodiment of the disclosure. The gas compensator 3 comprises a body 301, a piston 302, a spring 303 and a vent pipe 5. When the atmosphere temperature is changed, a volume of the gas compensator 3 may be changed to balance an internal and external pressure difference in the insulating glass by sucking the gas outside the insulating glass or discharge the gas in the gas compensator 3 through the vent pipe 5.

When the atmospheric temperature is changed, a pressure difference is generated between the atmospheric pressure and the pressure of the gas in the insulating glass 4. In order to maintain the balance between the atmospheric pressure and the pressure of the gas contained within the insulating glass 4, a gas suction/evacuation into and out of the gas compensator 3 is carried out through the vent pipe 5, i.e., the pressure in the insulating glass 4 is adjusted by a change in the volume of the gas compensator 3 so as to avoid the pressure difference from being generated in the insulating glass 4 due to the heat-expansion and cold-contraction. When the atmospheric temperature is decreased, the pressure in the insulating glass 4 is decreased correspondingly. Thus, the gas compensator 3 is subject to a negative pressure in the insulating glass 4 such that the piston 302 moves upwards, the spring 303 is stretched, and the air is sucked from the atmosphere through the vent pipe 5, such that the balance between the internal and external pressures of the insulating glass 4 is maintained. When the atmospheric temperature is increased, the pressure within the insulating glass 4 is increased. Thus, the gas compensator 3 is subject to the pressure within the insulating glass 4 so that the piston 302 moves downwards and the spring 303 is hereby compressed to discharge the gas out of the gas compensator through the vent pipe 5 so as to realize the balance between the internal and external pressures of the insulating glass 4 by the change in the volume of the gas compensator 3.

Therefore, the insulating glass assembly according to the embodiments of the disclosure may permanently equalize/balance the pressure difference between the internal and external pressures of the insulating glass, thereby improving safety performance of the insulating glass and the operation reliability of the a built-in insulating glass to ensure that the gas contained within the insulating glass may not escape therefrom.

It should be noted that the above embodiments are merely intended to describe the technical solution of the disclosure, rather than restrict thereto. Although the disclosure is described in details in the preferred embodiments thereof, it should be understood by those skilled in the art that various changes or modifications can be made without departing from the spirit and scope of the disclosure, and these changes or modifications should fall within the scope of the disclosure.

1. An insulating glass assembly comprising:
a piece of insulating glass; and
a gas compensator, wherein
the gas compensator is communicated with the insulating glass so as to form two separated cavities which are insulated from and thus not mutually communicated with each other, within a volume of the insulating glass assembly;
the gas compensator comprises a variable body and a vent pipe hermetically connected with the variable body; and
the vent pipe is in communication with atmosphere; and,
the gas compensator is configured such that a volume thereof is changed by an extension or a compression which the variable body of the gas compensator is subject to due to a pressure difference between the atmospheric pressure and the pressure of the gas in the insulating glass, such that a balance between the internal and external pressure of the insulating glass is maintained.

2. The insulating glass assembly according to claim 1, wherein the variable body is provided with a hole at an upper end thereof, through which the vent pipe passes.

3. The insulating glass assembly according to claim 1, wherein the insulating glass comprises an inner glass layer and an outer glass layer; and an interlayer is arranged between the inner glass layer and the outer glass layer, and filled with an inert gas.

4. The insulating glass assembly according to claim 1, further comprising a frame fixing the insulating glass and the gas compensator, wherein the vent pipe is communicated with the atmosphere through the frame and hermetically connected with the frame.

5. The insulating glass assembly according to claim 1, wherein the gas compensator is made of rubber.

6. The insulating glass assembly according to claim 1, wherein the gas compensator further comprises a piston and a spring.
